(19) United States
(12) Patent Application Publication
(10) Pub. No.: US 2020/0130676 A1
(43) Pub. Date: Apr. 30, 2020

(54) AUTONOMOUS VEHICLE PARKING SYSTEM

(71) Applicant: Magna Electronics Inc., Auburn Hills, MI (US)

(72) Inventor: G. Edzko Smid, Oxford, MI (US)

(21) Appl. No.: 16/662,188

(22) Filed: Oct. 24, 2019

Related U.S. Application Data
(60) Provisional application No. 62/872,809, filed on Jul. 11, 2019.
(60) Provisional application No. 62/750,351, filed on Oct. 25, 2018.

(51) Int. Cl. B60W 30/06; G05D 1/02

(52) U.S. Cl. CPC B60W 30/06; G05D 1/0212; G08G 1/14; G05D 1/0278; G05D 1/0231

(57) ABSTRACT

An autonomous parking system for a vehicle includes a plurality of sensors at the vehicle and a control including a processor that processes data captured by the sensors. The control, responsive to actuation of a first user input and to processing of captured data, generates a route from a drop-off location to a designated parking area using a designated navigation map. The control autonomously navigates the vehicle from the drop-off location to the designated parking area via the generated route. The control, while navigating the designated parking area, determines whether a parking space is available at the designated parking area. The control, responsive to determining that a parking space is available, parks the vehicle in the determined available parking space. The control, responsive to actuation of a second user input remote from the vehicle, autonomously navigates the vehicle out of the parking space and to a designated pickup area.

### CROSS REFERENCE TO RELATED APPLICATIONS

The present application claims priority of U.S. provisional application Ser. No. 62/872,809, filed Jul. 11, 2019, and U.S. provisional application Ser. No. 62/750,351, filed Oct. 25, 2018, which are hereby incorporated herein by reference in their entireties.

### FIELD OF THE INVENTION

The present invention relates generally to a vehicular control system and, more particularly, to a vehicular control system that utilizes a plurality of sensors at a vehicle.

### BACKGROUND OF THE INVENTION

Use of imaging and non-imaging sensors in vehicle control systems is common and known. Examples of such known imaging systems are described in U.S. Pat. Nos. 5,949,331; 5,670,935 and/or 5,550,677, which are hereby incorporated herein by reference in their entireties.

### SUMMARY OF THE INVENTION

The present invention provides a driver assistance system or vision system or imaging system for a vehicle that utilizes one or more image sensors or cameras and/or non-imaging sensors to capture image data and/or sensor data representative of the area exterior of the vehicle, and provides an electronic control unit (ECU) that includes a processor operable to process data captured by the sensors. The ECU, responsive to actuation of a first user input received wirelessly from a mobile device of an operator and to processing of data captured by the sensors, generates a route from a drop-off location, where an occupant in the vehicle exits the vehicle, to a designated parking area using a designated navigation map. The designated navigation map includes at least one selected from the group consisting of (i) lane sections of the designated parking area, (ii) intersections of the designated parking area; and (iii) parking spaces of the designated parking area. Responsive at least in part to processing by the processor of data captured by the sensors, the ECU autonomously navigates the vehicle from a drop-off location to the designated parking area. The ECU, while navigating the designated parking area, determines whether a parking space is available and, responsive to determining a parking space is available, parks the vehicle in the determined parking space. The ECU, responsive to parking the vehicle in the determined available parking space, transmits a parking confirmation signal to the mobile device of the operator and the parking confirmation signal includes information pertaining to the location of the parked vehicle.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates cameras in accordance with the present invention;

FIG. 2 is a plan view of the vision system of FIG. 1 with surround view cameras in accordance with the present invention;

FIG. 3 is a plan view of the vision system of FIG. 1 with surround view cameras and ultrasonic sensors in accordance with the present invention;

FIG. 4 is a plan view of a parking lot divided into lane sections, intersections, and parking spots;

FIG. 5 is a perspective view of a user input for commanding an autonomous parking maneuver;

FIG. 6 is a flow chart describing an exemplary autonomous parking maneuver;

FIG. 7 is a perspective view of a user input for commanding an autonomous pickup maneuver;

FIG. 8 is a flow chart describing an exemplary autonomous pickup maneuver;

FIGS. 9A-9D are plan views of a parking lot with pickup locations and drop off locations in accordance with the present invention;

FIGS. 10A and 10B are plan views of the parking lot with pickup locations and drop off locations in accordance with the present invention;

FIGS. 11A and 11B are plan views of the parking lot with programmed routes;

FIGS. 12A and 12B are plan views of the parking lot with additional pickup locations and drop off locations in accordance with the present invention;

FIG. 13 is a plan view of the parking lot with a canceled parking maneuver route;

FIGS. 14A-C are plan views of collision avoidance maneuvers;

FIGS. 15A and 15B are more plan views of collision avoidance maneuvers;

FIGS. 16A and 16B are more plan views of collision avoidance maneuvers;

FIG. 17 is a plan view of a parking lot with a handicap parking space; and

FIG. 18 is plan views of an application providing information in accordance with the present invention.

### DESCRIPTION OF THE PREFERRED EMBODIMENTS

A vehicle vision system and/or driver assist system and/or auto-park system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide display, such as a rearview display or a top down or bird's eye or surround view display or the like.

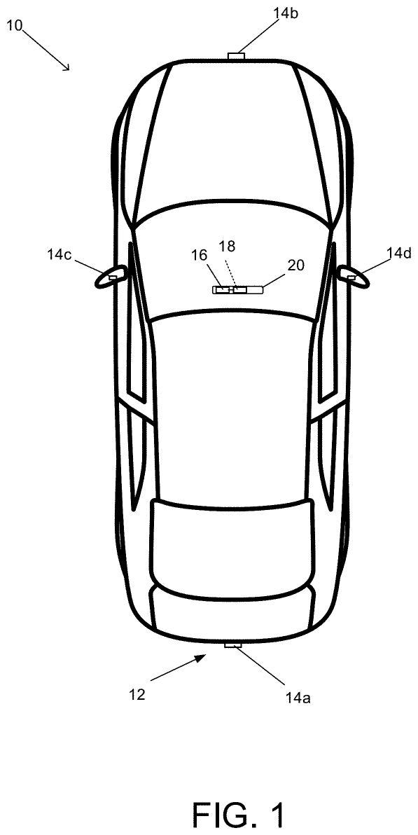

Referring now to the drawings and the illustrative embodiments depicted therein, a vehicle 10 includes an imaging system or vision system or driving assist system or autonomous parking and/or retrieval system 12 that includes at least one exterior viewing or sensing imaging sensor or camera and/or non-imaging sensor, such as a rearward viewing imaging sensor or camera 14a (and the system may optionally include multiple exterior viewing imaging sensors or cameras, such as a forward viewing camera 14b at the front (or at the windshield) of the vehicle, and a sideward/rearward viewing camera 14c, 14d at respective sides of the vehicle), which captures data representative of the scene exterior of the vehicle, with the camera having a lens for focusing images at or onto an imaging array or imaging plane or imager of the camera (FIG. 1). Optionally, a forward viewing camera may be disposed at the windshield of the vehicle and view through the windshield and forward of the vehicle, such as for a machine vision system (such as for traffic sign recognition, headlamp control, pedestrian detection, collision avoidance, lane marker detection and/or the like). The system 12 includes a control or electronic control unit (ECU) or processor 18 that is operable to process image data captured by the camera or cameras and may detect objects or the like and/or provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

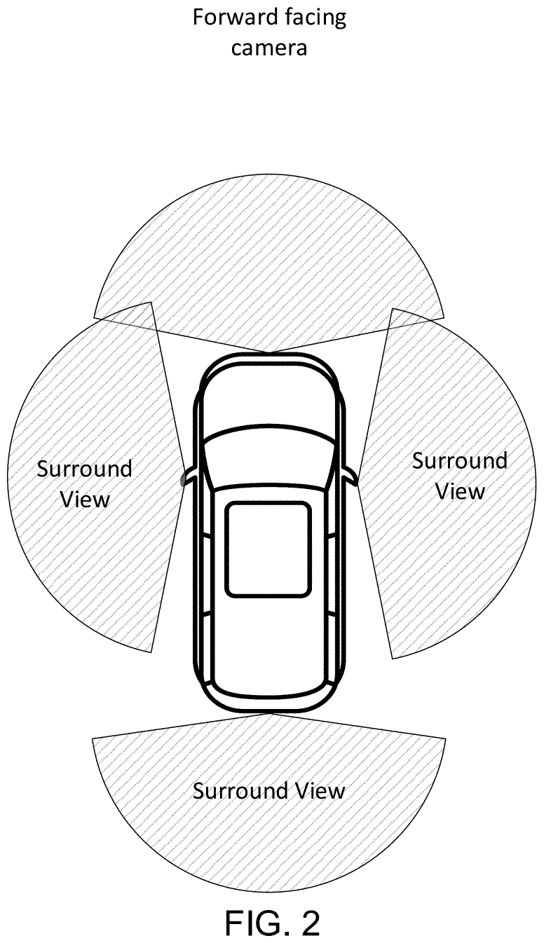

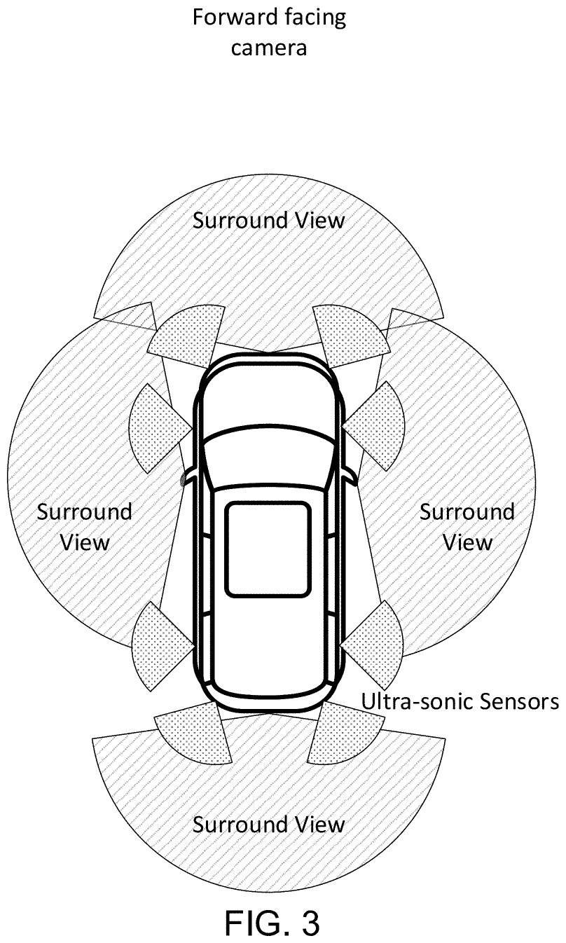

Referring now to FIG. 2, the system may include multiple cameras to provide a surround view of the vehicle. That is, multiple cameras placed around the vehicle may provide the system with essentially an uninterrupted view 360 degrees around the vehicle. The fields of view of the cameras may overlap to some degree to ensure no interruption in the surround view. Referring now to FIG. 3, in some implementations, the system includes a plurality of ultrasonic sensors that have a field of sensing around the vehicle. The ultrasonic sensors may provide essentially a 360 degrees of sensing around the vehicle or instead be concentrated near the front and rear of the vehicle. Ultrasonic sensors provide the system the ability to measure the distances to obstacles and monitor the space near the vehicle while parking and maneuvering.

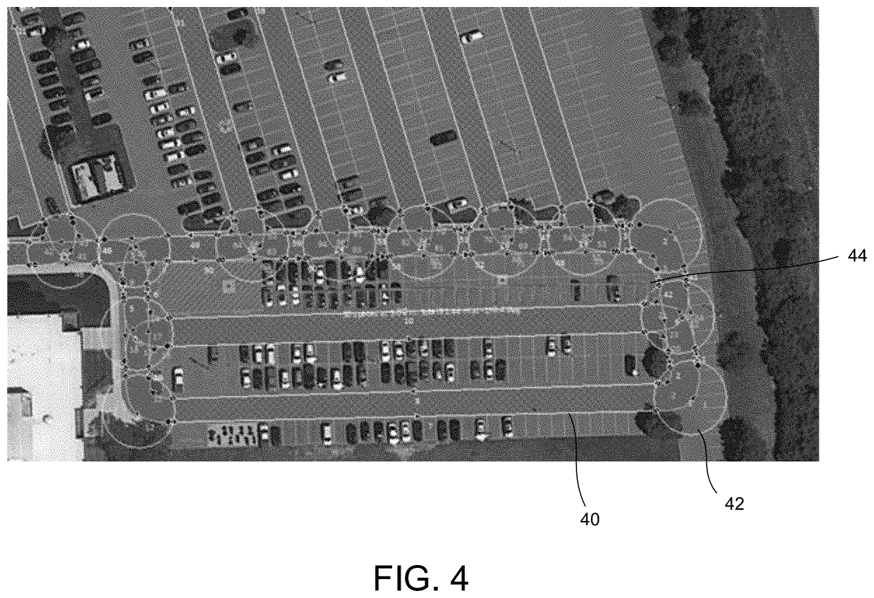

The system may operate in parking lots (or parking structures or any area designated for parking) where a designated navigation map is available. The designated navigation map may include lane sections 40, intersections 42, and parking spaces 44 of the parking lot (see FIG. 4). The map may be stored in a database of navigation maps (e.g., of known parking lots) either locally at the vehicle or accessible via wireless communication from the vehicle (e.g., the Internet or the user's mobile device). For example, the vehicle may search for a map online based on the current vehicle location. When navigating, the vehicle dynamically generates a route from any starting point to any destination point on the map. As shown in FIG. 4, the route may include a combination of lanes and intersections, and may be dynamically generated from any starting point to any destination point in a parking lot or parking structure that on the map.

The control, in response to actuation of a user input, and via processing of data captured by imaging and/or non-imaging sensors of the vehicle, autonomously navigates the vehicle (via controlling the acceleration and steering and braking of the vehicle) from a drop-off location to a designated parking area within the parking lot or structure within the designated navigation map. That is, the control, via the processing of the data captured by the sensor or sensors (e.g., the cameras and/or ultrasonic sensors and/or radar sensors and/or GPS sensors), navigates the vehicle without any input from a driver of the vehicle to a parking lot, parking structure, or other area designated for vehicle parking. The vehicle has access to GPS navigation (or some other means of determining current geographical location). In some examples, the vehicle may receive at least a portion of navigation from a mobile device of the user. For example, the vehicle may obtain GPS location from a GPS sensor of the user's mobile device. The user input may, for example, be a button, dial, switch, or any other user input located inside the vehicle. The user input may then further include closing a door of the vehicle. That is, the control may engage the auto-park system in response to actuation of a user input within the vehicle and the driver door of the vehicle being subsequently closed. This allows for the driver to exit the vehicle at the designated drop-off location prior to the vehicle beginning its autonomous parking procedure.

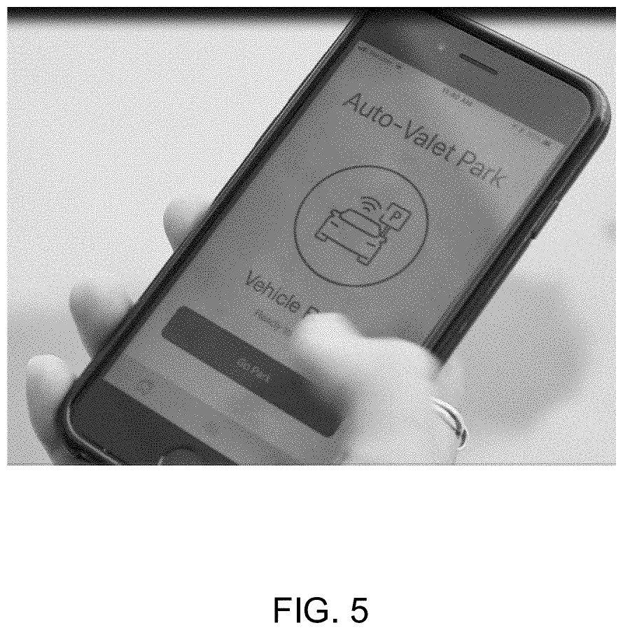

The user input may also be actuation of an input by a user of an application executing on a mobile device. For example, and such as shown in FIG. 5, a user (e.g., the driver or a passenger of the vehicle) may open an application (app) on his or her mobile device and command the vehicle to engage the autonomous parking maneuver. The mobile device may be in wireless communication with the vehicle (e.g., via LTE, Bluetooth, etc.). The designated parking area may be predetermined (i.e., determined during an initial setup or initialization of the system). The designated parking area may also be designated by the user when engaging the autonomous parking procedure (e.g., through a touchscreen within the vehicle or through the app on the mobile device). The designated parking area may also be learned by the system through observed prior behavior of the driver of the vehicle. That is, the control may observe the area where the vehicle has been parked on previous occasions and store that location in memory, whereby the control may automatically determine the designated parking area from such prior trips.

After receiving the command to engage the autonomous parking maneuver and navigating to the designated parking area, the system determines whether a parking space is available using, for example, image processing of image data captured by the camera or cameras of the vehicle. The system may base the determination on past behavior or preferences observed from the driver of the vehicle. For example, the system may observe a preferred parking location from the driver and may store such preferred parking locations in memory. When a parking space is determined available, the system parks the vehicle in the determined parking space. The system may notify the driver or a user of the successful park. The notification may include other information, such as the location of the vehicle or pictures of its surroundings.

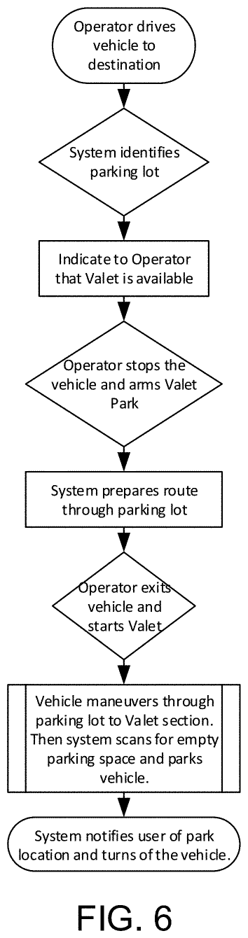

Referring now to FIG. 6, an exemplary flow chart of an autonomous parking maneuver is provided. First, the operator drives the vehicle to the desired destination. The desired destination may be, for example, any available parking space to their liking or the entrance of a building. Once the system has access to a navigation map (i.e., the system determines that the vehicle has entered an area with an available navigation map), the system indicates and/or notifies the operator (e.g., via a display within the vehicle) that autonomous parking (e.g., an auto valet parking mode) is available. During this time, the operator may continue to navigate to the desired destination. Once arrived, if the operator chooses to use the valet mode (as opposed to manually parking), the operator arms or engages the valet parking mode, as previously discussed. In some examples, the valet system must be armed by the operator prior to leaving the vehicle (e.g., by actuating an input within the vehicle) to prepare the system to take control and then engaged (e.g., via the user's mobile device) after leaving the vehicle. The system then generates and/or prepares the route through the parking lot. After the operator exits the vehicle, the valet mode engages and the vehicle maneuvers through the parking lot using the generated route and scans for empty or available parking spaces to park the vehicle. The system may lock the vehicle doors after the operator exits the vehicle and the valet mode is engaged. After parking the vehicle, the system may notify the user of the parking location and turns off the vehicle.

In some implementations, the system generates the route using an A-star (A*) search technique to determine the most optimal route from a starting point to a destination point on the navigation map. When the system determines that a point along the route is blocked (e.g., blocked by a stopped car), the system may dynamically find an alternative route to the destination.

The driver or user may also request information from the vehicle at any time via the application on the mobile device (e.g., location, temperature, etc.). For example, the user may actuate a user input on a mobile device (e.g., a button on an app) and the vehicle may respond with a wireless transmission of the requested information. In some examples, the application may display a map and update the vehicle's current location in real-time on the map. When the system fails to find a parking space available, the system may notify the driver or user of the vehicle of the failure. The notification may be sent after a threshold period of time searching has passed. The system may continue to navigate the designated parking area until a parking space is determined available. The system may also only navigate the designated parking area for a threshold period of time then return to a different location (e.g., the drop-off location or other location designated by the driver). The driver or user may also command the vehicle to return after receiving the notification of failure to park.

For example, when a user actuates the auto-park system at or near a parking facility in which the vehicle has been previously parked, the system may control the vehicle to go to a preferred or stored parking space or location. If that space is available, the system parks the vehicle at that space and notifies the driver of a successful parking. If the preferred space is not available, the system may control the vehicle to go to a secondary preferred space or to any available space at or near the preferred space or elsewhere at the parking facility. The system may store one or multiple preferred parking spaces and may proceed from a first preferred space to a second preferred space and so on until an available space is found.

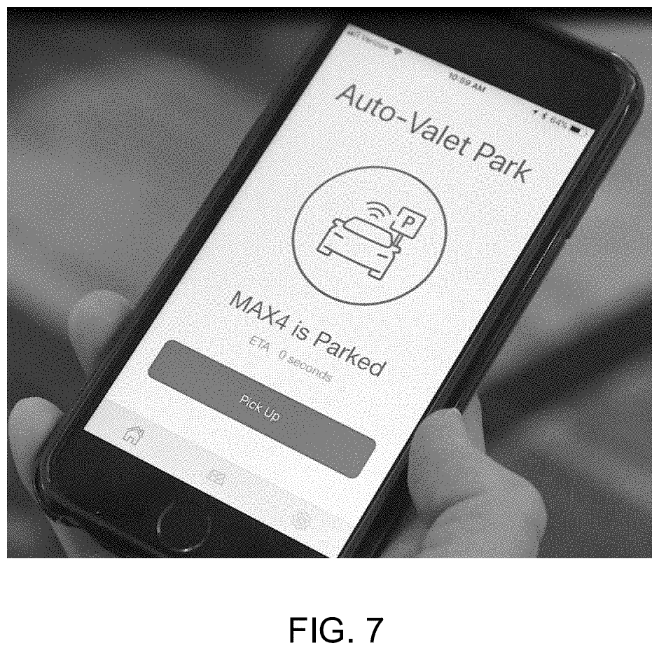

After successfully parking, the system may receive, in response to actuation of a remote user input, a pickup command. For example, as illustrated in FIG. 7, the driver or user may actuate a user input on the application on the mobile device. In response to receiving this command, the system autonomously navigates out of the parking space and to a designated pickup area. The designated pickup area may be a predetermined geographical location (e.g., set by the user prior to leaving the vehicle). The designated pickup area may also be the same location as the drop-off location. The driver or user may also designate the pickup area from the application when commanding the pickup maneuver. The system may also receive the location of the mobile device (e.g., via a GPS sensor of the mobile device) and automatically navigate as close as possible to the received location. The system may notify the driver or user that the pickup command was received. The system may provide an estimated time of arrival (ETA) that may be displayed on the application (see FIG. 7). Once arriving at the designated pickup area, the vehicle may notify the driver or user that the vehicle is safe to enter (e.g., by flashing lights, honking a horn, and/or sending a notification to the application).

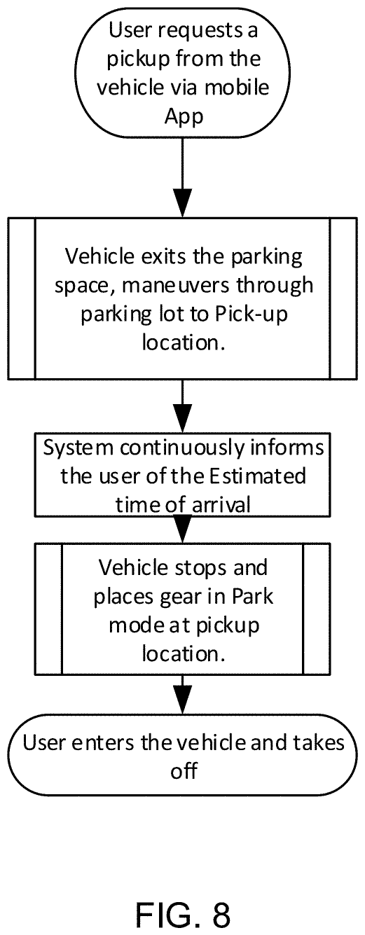

Referring now to FIG. 8, an exemplary flow chart of a pickup maneuver is provided. For example, after the user requests pickup (e.g., via the application on the user's mobile device or via a key fob of the vehicle), the vehicle exits the parking space and maneuvers through parking lot to the pickup location. The system generates a route that is the shortest or otherwise the most optimal to the pickup location. The system may continuously (or at some regular interval) provide the user with ETAs. Once at the pickup location, the vehicle stops and places the vehicle in the parking gear. The system may unlock the doors at this point or wait for further action from the user prior to unlocking the doors (e.g., unlock the doors when the user places his or her hand on a door handle). The user may then enter the vehicle. Because the system automatically and dynamically generates a route from any parking location to the pickup location, the vehicle may be manually parked by the operator but the operator may still request a valet pickup from the system.

Thus, the present invention provides a valet park system that includes a database of maps for known parking lots (or finds them find via searching online) based on the current vehicle location. The system is assumed to have GPS navigation or otherwise have knowledge of the current geographical location. For example, the location information of the user's mobile phone may be used as the current vehicle location. Once the system has access to a navigation map, the system notifies the user that it is able to auto-valet park the vehicle if desired. The user may still park the vehicle in any available parking space to their liking or, for example, may choose to exit the vehicle at the entrance of the building and use the auto valet system. The user may arm or initiate the system before exiting the vehicle, to prepare the system to take over the control of the vehicle. The system will prepare a route and when the user issues the valet command via, for example, an application on the user's mobile device, the system will lock the doors and maneuver the vehicle through the parking lot and park the vehicle in an available parking space in the designated valet park area.

When the user would like to request an auto valet, the user may use the mobile application to request a pickup. The pickup may be at the current location as determined by the mobile device (such as by determination of the GPS of the mobile device), or at a pre-determined location as designated on the map, or at the last drop-off location. When receiving the request, the system will start the vehicle, exit the parking space and determine the shortest route to the pickup location. While navigating the parking lot, the system may continuously report the estimated time of arrival to the user via the mobile application. When arriving at the pickup location, the system may maneuver the vehicle carefully and slowly to the curbside, place the vehicle in park, unlock the doors, and allow the user to enter the vehicle and take off.

The vehicle may be parked in any parking space in the parking lot and allow the user to request a pickup. In other words, the user may have parked the vehicle in manual mode, but would like a pickup from the autonomous valet system. Since the system is able to determine a route from any starting point to any destination point on the map, the vehicle may be parked anywhere in the parking lot.

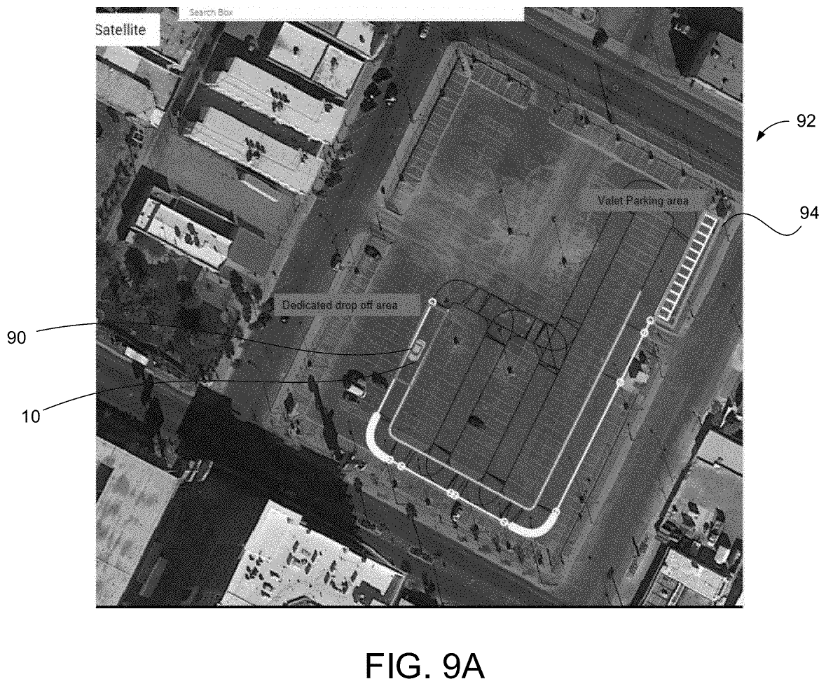

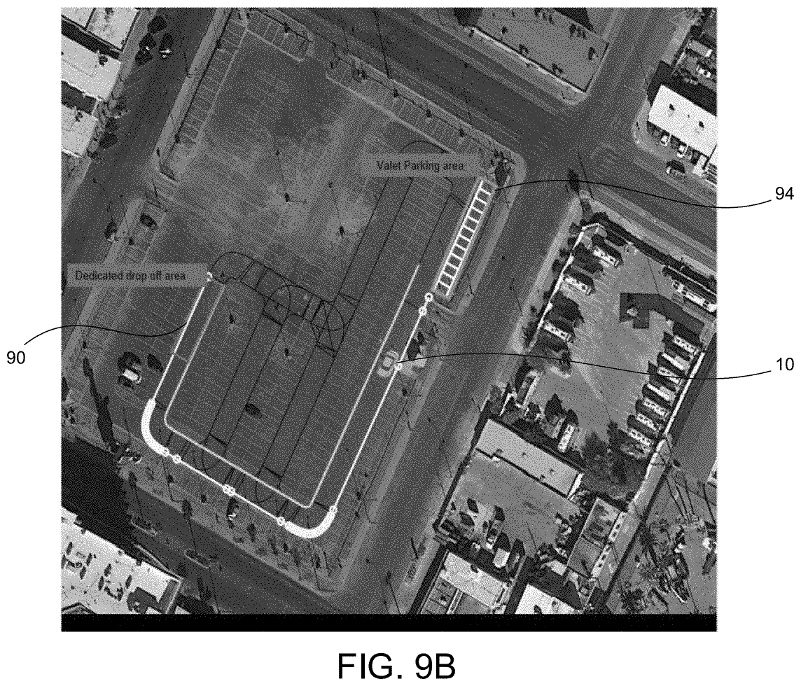

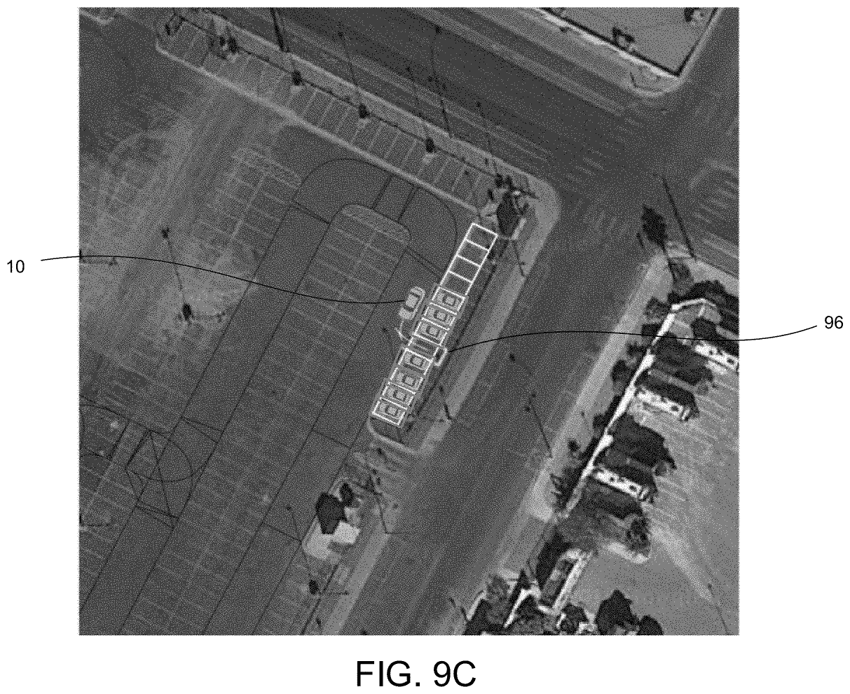

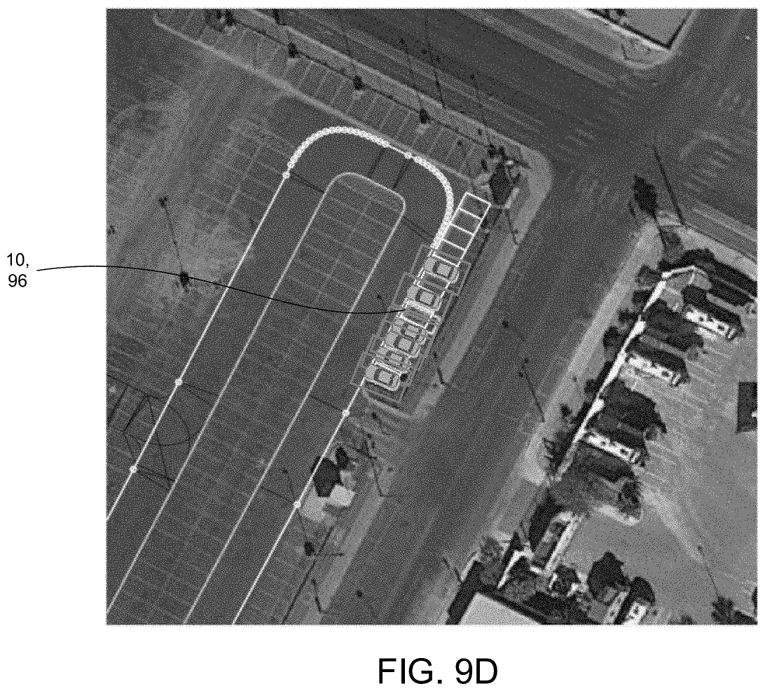

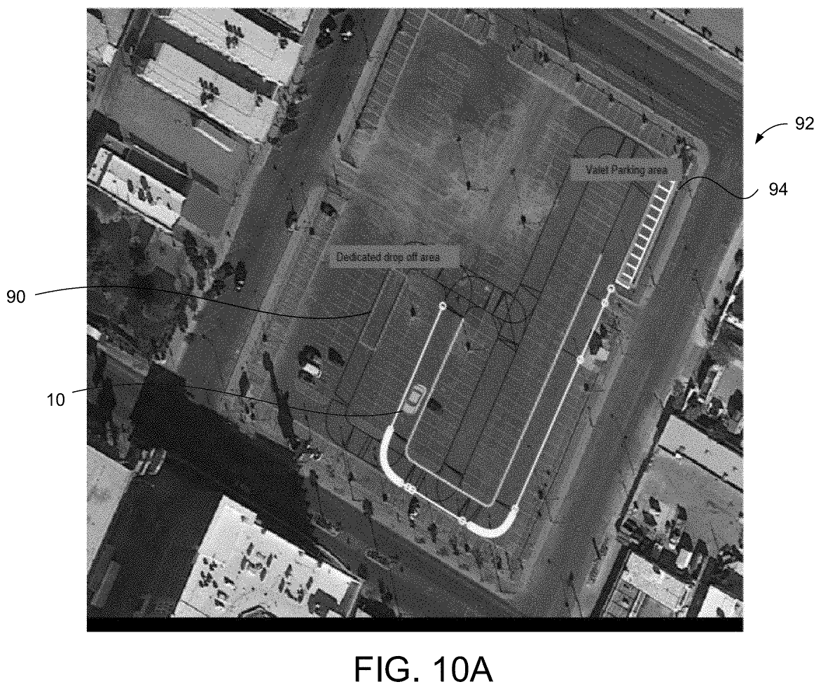

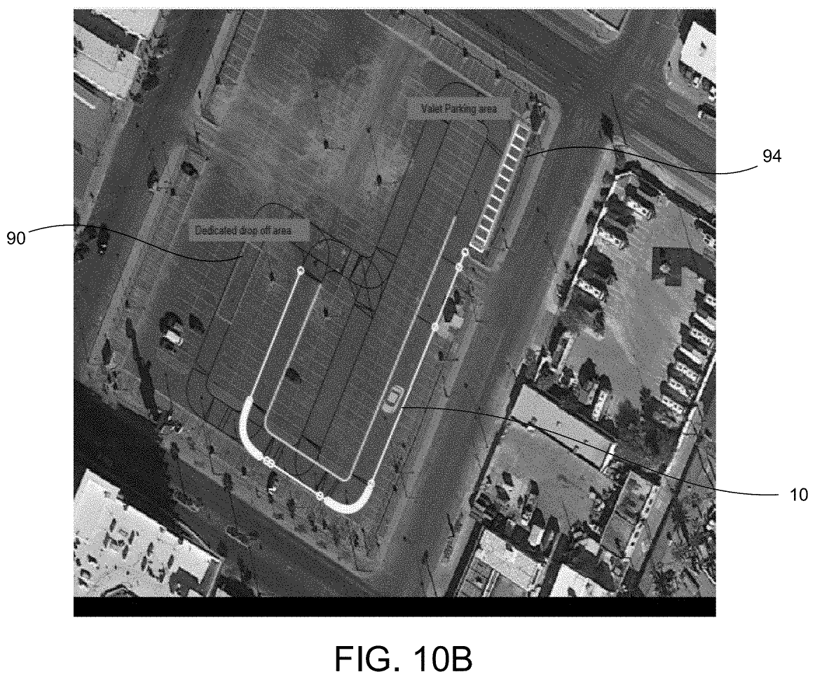

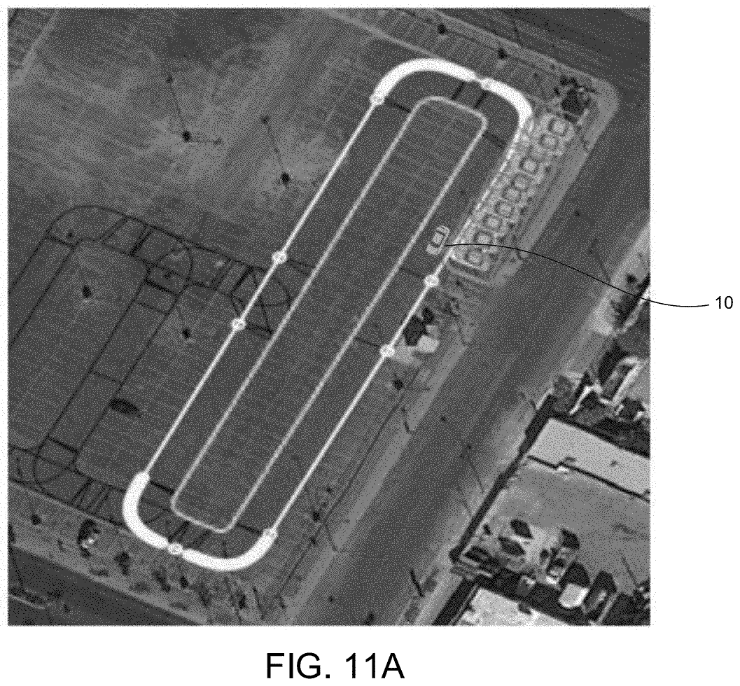

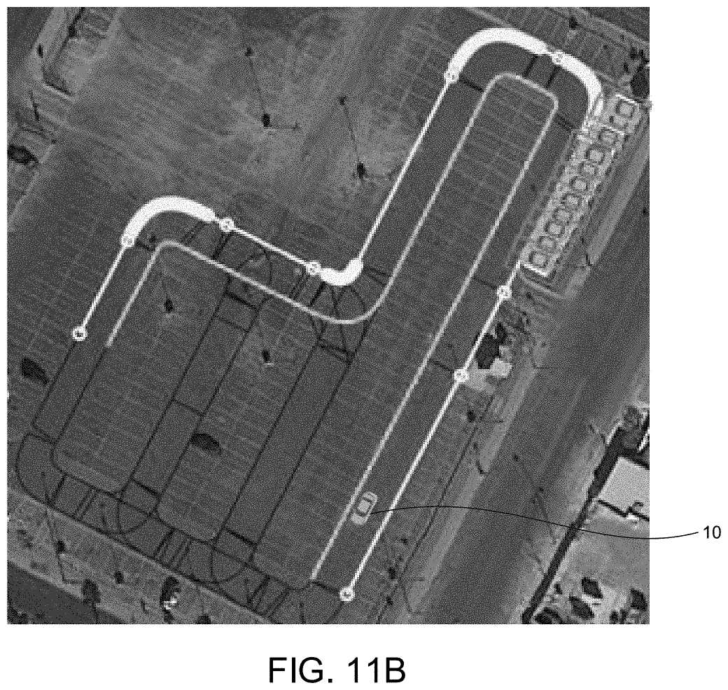

Referring now to FIGS. 9A-10B, in some examples, the user or driver drives the vehicle to a dedicated drop off zone 90 within a surveyed parking lot area 92 and stops the vehicle 10 (FIGS. 9A and 10A). The user may engage the autonomous valet parking system 12 by, for example, putting the vehicle into park and actuating a park engage button (e.g., on a display within the vehicle). The user may exit the vehicle and shut the door. In some implementations, the vehicle begins autonomously parking upon shutting the driver door. In other implementations, the user uses, for example, smart phone application (app) of a mobile device to command the vehicle to begin an autonomous valet park. For example, the user may actuate a user input of the mobile device to wirelessly transmit a signal to the vehicle (e.g., the ECU of the vehicle). In response to receiving the signal, the system may navigate the vehicle to a dedicated parking zone 94 (FIGS. 9B and 10B) and scan for empty spot parking spot (i.e., a spot safe for the vehicle to park in) (FIG. 9C). Upon detecting an empty parking spot 96, the system 12 may park the vehicle 10 in the detected spot (FIG. 9D). The vehicle may send user a notification of successful parking and/or the vehicle location. For example, the ECU may wirelessly transmit, responsive to successfully parking, a parking confirmation signal to the mobile device of the user. The drop off zone 90 may, for example, be a dedicated drop off zone (i.e., predetermined prior to parking) or any location within parking lot 92. If the system is unable to detect a valid parking space, the system may send a notification to the user (e.g., via the app). For example, the ECU may transmit a parking unavailable signal wirelessly to the mobile device of the user. The vehicle may continue to look for a parking space or return to the dedicated drop off area 90. In some implementations the vehicle may drive to a secondary designated parking area to look for an empty parking space. In some examples, after searching for an empty parking space for a set amount of time or scanning the parking lot a set number of times (FIG. 11A), the system may indicate to the user that parking is not available (i.e., transmit a “parking unavailable” message to the user's mobile device). The vehicle may return to the pick-up location and send an indication to the user (FIG. 11B). In some examples, the vehicle will continue to idle and send period notifications to the user (e.g., once a minute). After a set amount of time (e.g., 10 minutes), the vehicle may shut off.

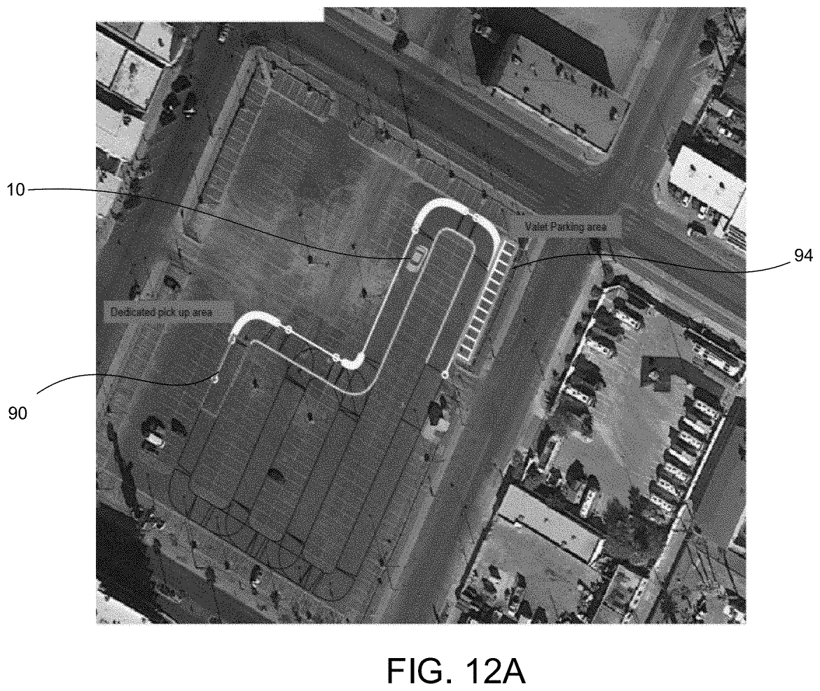

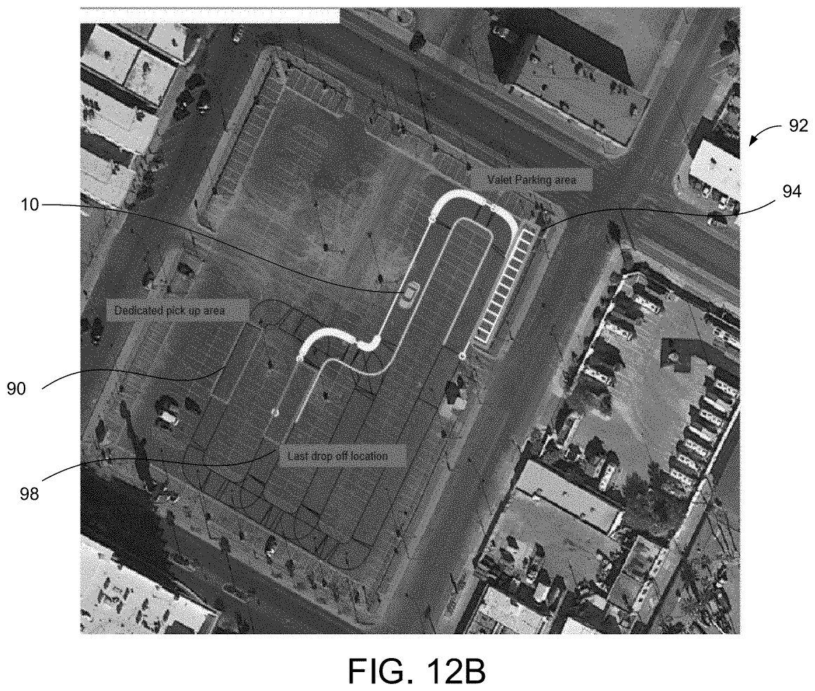

Referring now to FIGS. 12A and 12B, the vehicle 10, when instructed by the user (e.g., via the app) or via a schedule (e.g., at a specified time) may drive to a pick up location that from, for example, the dedicated parking zone 90 where the vehicle autonomously parked or any parking place the user manually parked the vehicle 10 (i.e., manually parked but autonomously picked up). In some implementations, the user sends a message to the system (e.g., via the app) with a request for pickup and information about the pickup location. For example, the user may indicate upon a map a desired pickup location, the user's mobile device may automatically send the user's location (e.g., using GPS functionality) to the vehicle, or the user may select a location from a list of predetermined pickup locations. For example, the user may actuate a user input of the mobile device to wirelessly transmit a signal to the vehicle (e.g., the ECU of the vehicle). Upon receiving the message or signal, the system 10 may respond with an acknowledgment (e.g., an alert in the app) or pick-up confirmation signal wirelessly transmitted to the mobile device of the user, the system may start the vehicle and exit the parking space (or parking location) and navigate the parking lot 92 toward the designated pickup location. In some examples, the system notifies the user of an estimated time to arrival at the designated pickup location. Upon arrival at the designated pickup location, the system may place the vehicle in park and notify the driver (e.g., via the app, blinking lights, and/or honking the horn) that the pickup maneuver has completed and user can enter the vehicle 10. In some implementations, the designated pickup location is the same as the initial drop-off location 90 (FIG. 12A), or, in other implementations, the last drop-off location 98 used by the vehicle (FIG. 12B). The designated pickup location may also be any point on the programmed route that is nearest to the current GPS location of user's smart phone or other mobile device.

In some implementations, after the vehicle 10 begins navigating the parking lot 92, the user may decide to pause the system 12 to, for example, retrieve a forgotten item from the vehicle. The user may transmit a pause message or signal to the system 12 from the user's mobile device (e.g., via the app). Upon receiving the pause message, vehicle 10 may stop at its current location and pause the autonomous valet parking. The system may indicate to the user that the vehicle is now safe to enter (e.g., blinking lights, honking horn, etc.). The user may transmit a resume message to the vehicle (e.g., from the app) when the user is ready for the autonomous parking to continue (for example, after retrieving the forgotten item) and vehicle may continue the autonomous valet parking.

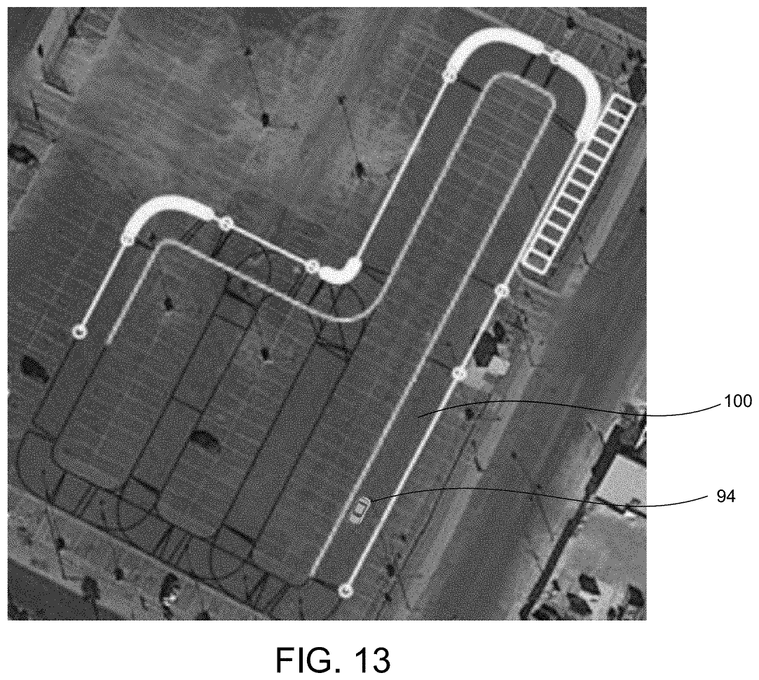

In some examples, after the vehicle 10 begins navigating the parking lot 92 to autonomously park, the user may decide to cancel parking. In this case, the user sends a cancel message or signal (e.g., via the app) to the system along with pickup location information. That is, the user may send a cancel message that includes the destination the vehicle is to return to. Upon receiving the cancel message, the vehicle may begin to navigate from the parking lot toward the pickup location indicated within the cancel message. Once arriving at the indicated pickup location, the system may place the vehicle in park and indicate to the user that the pickup maneuver has completed and the user can enter the vehicle. The pickup location may be, for example, the same location as a previous drop-off location, a pre-programmed pickup location, a point along a programmed or determined route 100 that is nearest to the current GPS location of user's smart phone (FIG. 13), etc. The user may also cancel an in progress pickup maneuver. That is, when the vehicle is navigating toward the pickup location, the user may cancel the maneuver and the vehicle may return to an available parking space.

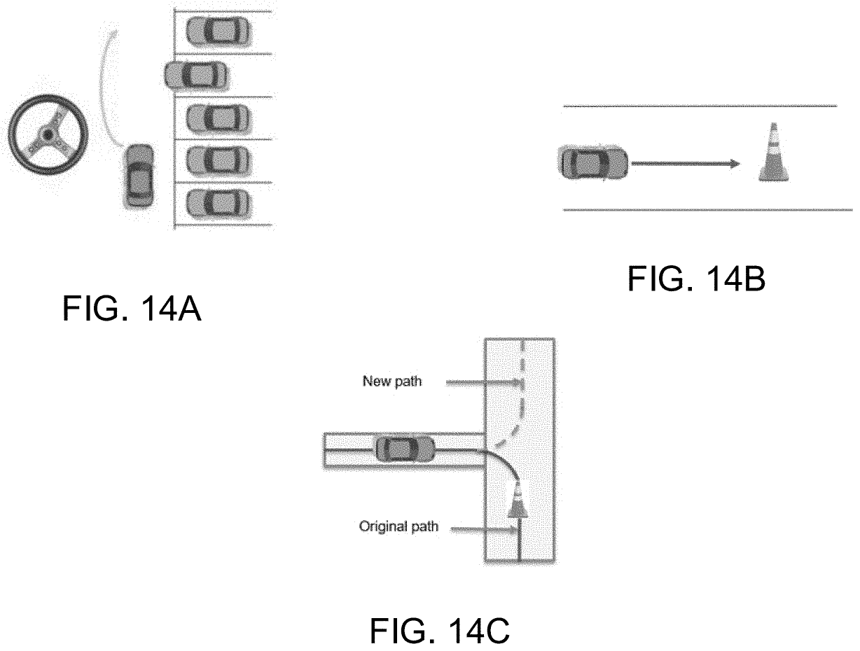

Referring now to FIGS. 14A-C, the system may include various collision prevention methods. For example, during parking lot navigation (either toward the pickup location or when scanning for an empty parking space), the vehicle may detect an object in the path of the vehicle (e.g., another vehicle). The system may determine the object is stationary or moving and any free space around object. Based upon these determinations, the system may steer around the object (FIG. 14A) when there is enough space or stop and wait for the object to move when there is not enough space (FIG. 14B). The vehicle may also find another route and continue navigating the parking lot (e.g., after waiting for a set amount of time for the object to move) (FIG. 14C). In some examples, when the system is unable to find a route to avoid the object, the vehicle may stop and notify the user with a message and current vehicle location.

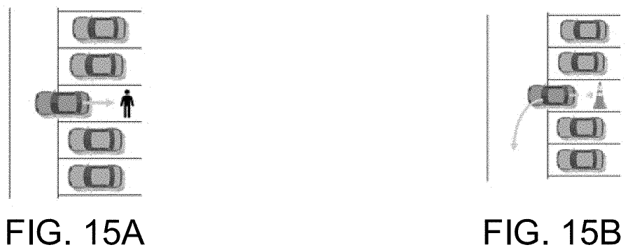

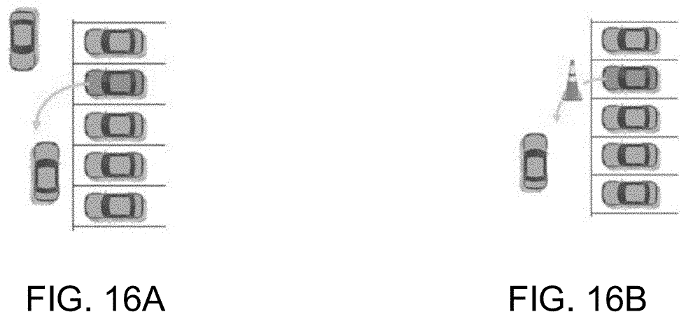

Referring now to FIGS. 15A and 15B, the system avoids collisions during parking maneuvers. For example, when the vehicle is pulling into an empty parking space and detects objects within the parking path, the vehicle may stop and wait until the object moves (or the space is otherwise free) and continue to complete the parking (FIG. 15A). If object does not move for a set amount of time (e.g., one minute), the vehicle may start to pull out and find another parking space to park (FIG. 15B). In some implementations, the system also avoids collisions when pulling out from a parking space (i.e., when navigating toward the pickup location). Referring now to FIGS. 16A and 16B, before the vehicle begins the pull out maneuver, the system may determine the presence of crossing traffic to determine if vehicle can safely being the maneuver (FIG. 16A). The vehicle may also be exiting the parking lot and detect an object that poses a risk of collision. In these examples, the vehicle may stop and wait until the object no longer poses a risk of collision before continuing to exit the parking spot (FIG. 16B) or parking lot. In some examples, when the object does not clear after a set amount of time (e.g., 10 minutes), the vehicle may stop and inform user (e.g., with a message via the app).

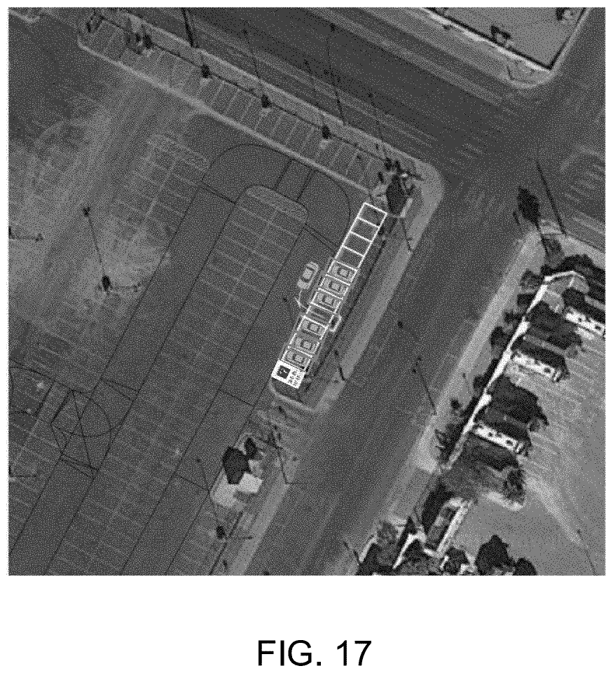

In some implementations, the user may query the location of the vehicle at any time via the user's mobile device. That is, the user may query the vehicle's location via the app, and the system may respond to the query with the vehicle's location (obtained, for example, via GPS). The system may be able to park in a variety of parking spaces using a variety of parking maneuvers. For example, the vehicle may parallel park, perpendicular head in park, perpendicular tail in park, fishbone head in park, etc. The system may support both left side parking and right side parking. In some examples, the system may recognize and avoid parking in handicap locations (FIG. 17).

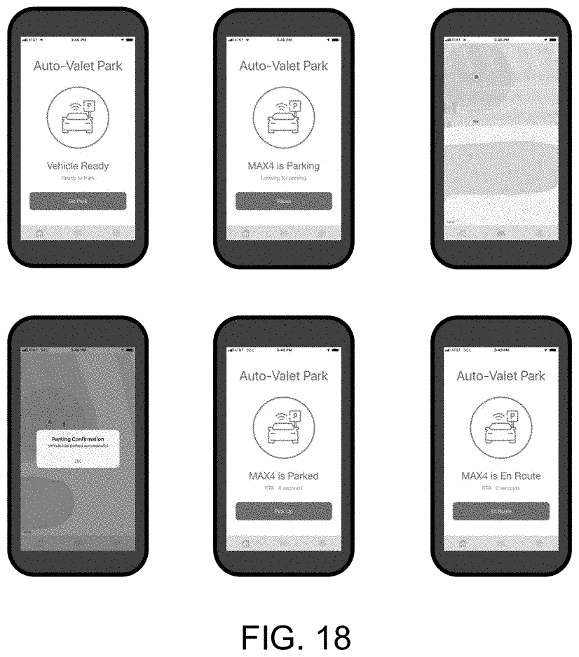

Referring now to FIG. 18, several exemplary views of the application are illustrated. The application may provide a variety of notifications and information to the user, such as when the vehicle is ready, when the vehicle is parking, when the vehicle is parked, and when the vehicle is en route. The app, in some examples, may indicate visually the location of the vehicle (e.g., using a map).

The system may utilize aspects of the parking assist systems described in U.S. Pat. No. 8,874,317 and/or U.S. Publication Nos. US-2017-0329346; US-2017-0317748; US-2017-0253237; US-2017-0050672; US-2017-0017847; US-2017-0015312 and/or US-2015-0344028, which are hereby incorporated herein by reference in their entireties.

For autonomous vehicles suitable for deployment with the system of the present invention, an occupant of the vehicle may, under particular circumstances, be desired or required to take over operation/control of the vehicle and drive the vehicle so as to avoid potential hazard for as long as the autonomous system relinquishes such control or driving. Such occupant of the vehicle thus becomes the driver of the autonomous vehicle. As used herein, the term “driver” refers to such an occupant, even when that occupant is not actually driving the vehicle, but is situated in the vehicle so as to be able to take over control and function as the driver of the vehicle when the vehicle control system hands over control to the occupant or driver or when the vehicle control system is not operating in an autonomous or semi-autonomous mode.

Typically an autonomous vehicle would be equipped with a suite of sensors, including multiple machine vision cameras deployed at the front, sides and rear of the vehicle, multiple radar sensors deployed at the front, sides and rear of the vehicle, and/or multiple lidar sensors deployed at the front, sides and rear of the vehicle. Typically, such an autonomous vehicle will also have wireless two way communication with other vehicles or infrastructure, such as via a car2car (V2V) or car2x communication system.

The system may utilize sensors, such as radar or lidar sensors or the like. The sensing system may utilize aspects of the systems described in U.S. Pat. Nos. 9,753,121; 9,689,967; 9,599,702; 9,575,160; 9,146,898; 9,036,026; 8,027,029; 8,013,780; 6,825,455; 7,053,357; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 6,919,549; 6,906,793; 6,876,775; 6,710,770; 6,690,354; 6,678,039; 6,674,895 and/or 6,587,186, and/or International Publication Nos. WO 2018/007995 and/or WO 2011/090484, and/or U.S. Publication Nos. US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

The system may also communicate with other systems, such as via a vehicle-to-vehicle communication system or a vehicle-to-infrastructure communication system or the like. Such car2car or vehicle to vehicle (V2V) and vehicle-to-infrastructure (car2X or V2X or V2I or a 4G or 5G broadband cellular network) technology provides for communication between vehicles and/or infrastructure based on information provided by one or more vehicles and/or information provided by a remote server or the like. Such vehicle communication systems may utilize aspects of the systems described in U.S. Pat. Nos. 6,690,268; 6,693,517 and/or 7,580,795, and/or U.S. Publication Nos. US-2014-0375476; US-2014-0218529; US-2013-0222592; US-2012-0218412; US-2012-0062743; US-2015-0251599; US-2015-0158499; US-2015-0124096; US-2015-0352953; US-2016-0036917 and/or US-2016-0210853, which are hereby incorporated herein by reference in their entireties.

The cameras or sensors may comprise any suitable cameras or sensors. Optionally, the camera may comprise a “smart camera” that includes the imaging sensor array and associated circuitry and image processing circuitry and electrical connectors and the like as part of a camera module, such as by utilizing aspects of the vision systems described in International Publication Nos. WO 2013/081984 and/or WO 2013/081985, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in International Publication Nos. WO 2010/144900; WO 2013/043661 and/or WO 2013/081985, and/or U.S. Pat. No. 9,126,525, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. An autonomous parking system for a vehicle, the autonomous parking system comprising:
a plurality of sensors disposed at the vehicle equipped with the autonomous parking system and having respective fields of sensing exterior of the vehicle;
an electronic control unit (ECU) disposed at the equipped vehicle and comprising a processor that processes data captured by the sensors;
wherein the ECU receives a signal wirelessly transmitted by a mobile device of an operator, and wherein the signal is wirelessly transmitted by the mobile device of the operator responsive to actuation by the operator of a first user input of the mobile device;
wherein the ECU, responsive to the signal wirelessly transmitted by the mobile device in response to actuation by the operator of the first user input of the mobile device, generates a route from a drop-off location, where an occupant in the vehicle exits the vehicle, to a designated parking area using a designated navigation map;
wherein the designated navigation map includes at least one selected from the group consisting of (i) lane sections of the designated parking area, (ii) intersections of the designated parking area; and (iii) parking spaces of the designated parking area;
wherein the ECU, responsive at least in part to processing by the processor of data captured by the sensors, autonomously navigates the vehicle from the drop-off location to the designated parking area via the generated route;
wherein the ECU, while navigating the designated parking area, determines whether a parking space is available at the designated parking area;
wherein the ECU, responsive to determining a parking space is available, parks the vehicle in the determined available parking space; and
wherein the ECU, responsive to parking the vehicle in the determined available parking space, transmits a parking confirmation signal to the mobile device of the operator, and wherein the parking confirmation signal includes information pertaining to the location of the parked vehicle.

2. The autonomous parking system of claim 1, wherein the ECU, responsive to receiving a second signal wirelessly transmitted by the mobile device in response to actuation by the operator of a second user input of the mobile device, generates a pickup route from the determined available parking space to a designated pickup area using the designated navigation map, and wherein the ECU, responsive to processing by the processor of data captured by the sensors, autonomously navigates the vehicle from the determined available parking space to the designated pickup area via the generated pickup route.

3. The autonomous parking system of claim 2, wherein the designated pickup area is a predetermined geographical location.

4. The autonomous parking system of claim 2, wherein the designated pickup area is the same as the drop-off location.

5. The autonomous parking system of claim 2, wherein the designated pickup area corresponds to a location of the mobile device when the second user input is actuated by the operator.

6. The autonomous parking system of claim 2, wherein actuation by the operator of the first user input comprises actuation of an input of an application executing on the mobile device, and wherein actuation of the second user input comprises actuation of another input of the application executing on the mobile device of the operator.

7. The autonomous parking system of claim 2, wherein the ECU, responsive to receiving the second signal wirelessly transmitted by the mobile device in response to actuation by the operator of the second user input, sends a confirmation to the mobile device of the operator.

8. The autonomous parking system of claim 2, wherein the ECU, responsive to receiving a third signal wirelessly transmitted by the mobile device in response to actuation by the operator of a third user input of the mobile device, sends information associated with a current location of the vehicle to the mobile device of the operator, and wherein the mobile device displays the current location of the vehicle.

9. The autonomous parking system of claim 1, wherein actuation by the operator of the first user input comprises actuation by the operator of an input of an application executing on the mobile device of the operator.

10. The autonomous parking system of claim 1, wherein the ECU navigates the vehicle to a predetermined parking space to determine if that parking space is available based on a previously stored parking space that is stored in memory based on past behavior observed from a driver of the vehicle.

11. The autonomous parking system of claim 10, wherein the past behavior comprises one selected from the group consisting of (i) a preferred parking space at the designated parking area and (ii) preferred lanes for navigating the designated parking area.

12. The autonomous parking system of claim 1, wherein the plurality of sensors comprises a plurality of cameras disposed at the vehicle and having respective fields of view exterior the vehicle.

13. The autonomous parking system of claim 1, wherein the designated navigation map is stored in non-volatile memory disposed within the vehicle.

14. The autonomous parking system of claim 1, wherein the ECU retrieves the designated navigation map via wireless communication.

15. The autonomous parking system of claim 1, wherein the ECU receives GPS data from the mobile device of the operator.

16. The autonomous parking system of claim 1, wherein the ECU, responsive to determining a parking space is not available, transmits a parking unavailable signal to the mobile device of the operator.

17. The autonomous parking system of claim 16, wherein the ECU, responsive to determining a parking space is not available, autonomously navigates the vehicle from the current location of the vehicle to the drop-off location responsive at least in part to processing by the processor of data captured by the sensors.

18. The autonomous parking system of claim 1, wherein the ECU, responsive to receiving a pause parking signal wirelessly transmitted by the mobile device of the operator, halts the vehicle at the current location of the vehicle, and wherein the ECU, responsive to receiving a resume parking signal wirelessly transmitted by the mobile device of the operator, resumes autonomous navigation of the vehicle from the drop-off location to the designated parking area.

19. An autonomous parking system for a vehicle, the autonomous parking system comprising:
a plurality of sensors disposed at the vehicle equipped with the autonomous parking system and having respective fields of sensing exterior of the vehicle;
an electronic control unit (ECU) disposed at the equipped vehicle and comprising a processor that processes data captured by the sensors;
wherein the ECU receives a signal wirelessly transmitted by a mobile device of an operator, and wherein the signal is wirelessly transmitted responsive to actuation by the operator of a first user input of the mobile device;
wherein the ECU, responsive to receiving the signal wirelessly transmitted by the mobile device of the operator in response to actuation by the operator of the first user input of the mobile device, generates a route from a designated parking area to a pick-up location using a designated navigation map;
wherein the designated navigation map includes at least one selected from the group consisting of (i) lane sections of the designated parking area, (ii) intersections of the designated parking area; and (iii) parking spaces of the designated parking area;
wherein the ECU, responsive to generating the route, transmits a pick-up confirmation signal to the mobile device of the operator;
wherein the ECU, responsive at least in part to processing by the processor of data captured by the sensors, autonomously navigates the vehicle from the designated parking area to the pick-up location via the generated route; and
wherein the ECU, while the ECU autonomously navigates the vehicle from the designated parking area to the pick-up location via the generated route, sends information associated with a current location of the vehicle to the mobile device of the operator for displaying at the mobile device the current location of the vehicle.

20. An autonomous parking system for a vehicle, the autonomous parking system comprising:
a plurality of sensors disposed at the vehicle equipped with the autonomous parking system and having respective fields of sensing exterior of the vehicle;
an electronic control unit (ECU) disposed at the equipped vehicle and comprising a processor that processes data captured by the sensors;
wherein the ECU receives a signal wirelessly transmitted by a mobile device of an operator, and wherein the signal is wirelessly transmitted by the mobile device of the operator responsive to actuation by the operator of a user input of the mobile device;
wherein the ECU, responsive to the signal wirelessly transmitted by the mobile device in response to actuation by the operator of a first user input of the mobile device, generates a route from a drop-off location, where an occupant in the vehicle exits the vehicle, to a designated parking area using a designated navigation map;
wherein the ECU retrieves the designated navigation map via wireless communication;
wherein the designated navigation map includes at least one selected from the group consisting of (i) lane sections of the designated parking area, (ii) intersections of the designated parking area; and (iii) parking spaces of the designated parking area;
wherein the ECU, responsive at least in part to processing by the processor of data captured by the sensors, autonomously navigates the vehicle from the drop-off location to the designated parking area via the generated route;
wherein the ECU navigates the vehicle to a predetermined parking space to determine if that parking space is available based on a previously stored parking space that is stored in memory based on past behavior observed from a driver of the vehicle;
wherein the ECU, responsive to determining the predetermined parking space is available, parks the vehicle in the predetermined parking space;
wherein the ECU, responsive to parking the vehicle in the predetermined parking space, transmits a parking confirmation signal to the mobile device of the operator, and wherein the parking confirmation signal includes information pertaining to the location of the parked vehicle;
wherein the ECU, responsive to receiving the signal wirelessly transmitted by the mobile device of the operator in response to actuation by the operator of a second user input of the mobile device, generates a route from the parking space to a pick-up location using the designated navigation map;
wherein the ECU, responsive to generating the route from the parking space to the pick-up location, transmits a pick-up confirmation signal to the mobile device of the operator;
wherein the ECU, responsive at least in part to processing by the processor of data captured by the sensors, autonomously navigates the vehicle from the parking space to the pick-up location via the generated route; and
wherein the ECU, while the ECU autonomously navigates the vehicle from the designated parking area to the pick-up location via the generated route, sends information associated with a current location of the vehicle to the mobile device of the operator for displaying at the mobile device the current location of the vehicle.
